(19) United States
(12) Patent Application Publication
(10) Pub. No.: US 2017/0256186 A1
(43) Pub. Date: Sep. 7, 2017

(54) DISPLAY ARRANGEMENT

(71) Applicant: Sockatyes Holding Limited, Kowloon, Hong Kong (CN)

(72) Inventor: Russell POINTON, Kowloon, Hong Kong (CN)

(73) Assignee: Sockatyes Holding Limited, Kowloon, Hong Kong (CN)

(21) Appl. No.: 15/517,453

(22) PCT Filed: Sep. 3, 2015
(86) PCT No.: PCT/IB2015/056702

§ 371 Date: Apr. 6, 2017

(30) Foreign Application Priority Data
Oct. 7, 2014 (GB) 1417718.2
Oct. 9, 2014 (GB) 1417851.1

(51) Int. Cl. G09F 21/02; A63B 71/06

(52) U.S. Cl. CPC G09F 21/02; A63B 71/0619; G09F 2021/023; A63B 2071/0602; A63B 2071/0661; A63B 2071/0694; A63B 2209/10; A63B 2243/0025; G06Q 30/0241

(57) ABSTRACT

A display arrangement 10 is to be worn when playing sport. The arrangement comprises a first part 12 in the form of a planar piece 16 of textile material which decal may be applied. A second part 14 in the form of a length of a textile tape 24 is provided which threads through slots 20 in the first part 12 and can be formed into a loop to retain the arrangement 10 on a person's leg.

This invention concerns a display arrangement, and particularly but not exclusively a display arrangement which can be worn whilst playing sport, and in particular football.

In sport and particularly professional football, it is commercially desirable to provide as much space as possible on a player's clothing to permit advertising, sponsorship or other endorsements to be worn which can be viewed by a spectator, and particularly a spectator watching a football match on television.

According to the present invention there is provided a display arrangement to be worn when playing sport, the arrangement including a first part which is at least generally planar and can bear an image or other decoration, and a second part which is flexible and elongate and can support the first part and can be formed into a loop to extend around a player's lower leg and to be worn thereon.

A tab part may be provided on the second part which extends outwardly therefrom when the second part is in a loop, which tab part can be pulled to break open the loop to enable the arrangement to be removed from a player.

A first engagement part may be provided at one end of the second part, with a second engagement part provided at least towards the other second end of the second part, which first and second engagement parts are engageable together to form the second part into a loop.

The tab part may be provided at the second end of the second part and may be provided at the second end beyond the second engagement part. The tab part may be in the form of the second end of the second part being folded back onto itself and mounted together to provide a tab part of double thickness.

The first and second engagement parts may be provided by respective engageable strips of fleece and hook fastener, and the strips may be provided on respective opposite sides of the second part.

The second part may be in the form of a length of textile material, which may be a tape, which material may have a limited amount of stretch, which stretch may be up to between 5 and 20%, and may be up to between 8 and 16%

The stretch in the material of the second part may be provided by applying a plurality of heat compactions of the material of the second part.

The second part may be made from polyester, or a polyester and cotton mix.

The first part may include a pair of spaced openings through which the second part can extend to retain the first part on the second part when in the form of a loop

The first part may be made of a flexible textile material, and may be made from polyester, or a polyester and cotton mix.

The first part may be configured so as to generally lie against a wearer of the arrangement in use.

A decal may be applied to the first part, and the decal may be personalised to a wearer of the arrangement. The decal may be a heat press transfer.

The arrangement may include a security marking provided therein.

The security marking may not be substantially visible to the naked eye, but may be visible using a laser.

An embodiment of the present invention will now be described by way of example only and with reference to the accompanying drawings, in which:

FIG. 1 is a diagrammatic rear perspective view of a pair of display arrangements according to the invention being worn by a football player;

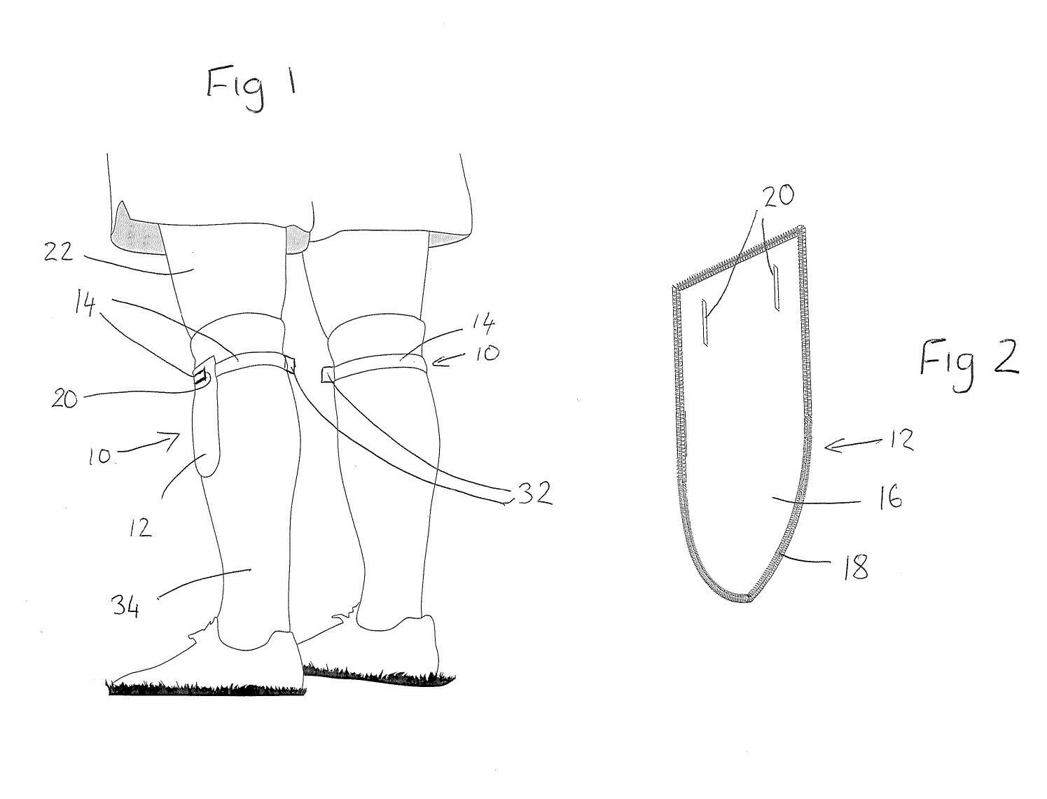

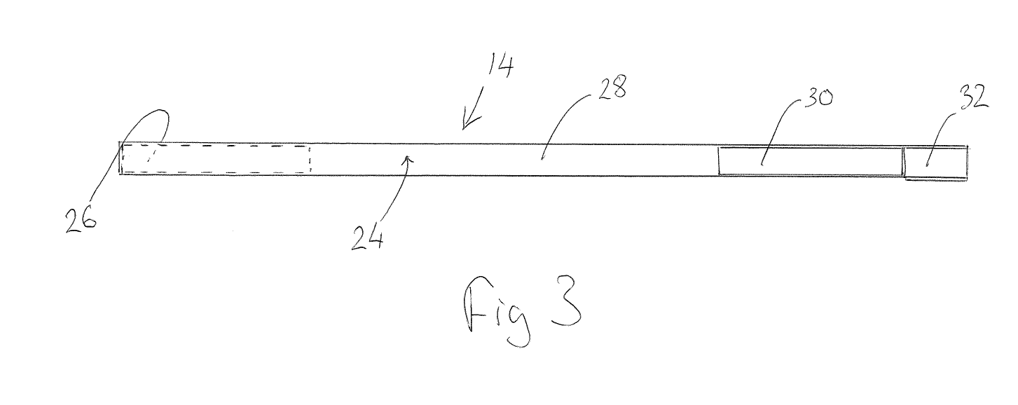

FIG. 2 is a diagrammatic perspective view of a first part of a one of the arrangements of FIG. 1; and

FIG. 3 is a diagrammatic plan view of a second part of a one of the arrangements of FIG. 1.

The drawings show a display arrangement 10 comprising a first part 12 and a second part 14. The first part 12 comprises a planar piece 16 of textile material, which in this instance is generally in the shape of a shield, but other shapes could be used. A ribbed edge 18 is provided around the piece 16. A decal may be applied to the first part 12, and the decal may be personalised to a wearer of the arrangement, and for instance may include the wearer's name and/or a squad number or the like. The decal may be a heat press transfer.

A spaced pair of vertically extending slots 20 are provided towards the top of the piece 16 spaced from each other, at the same height, and parallel to each other. The first part 12 is of a material such that as shown in FIG. 1 the first part will generally lie substantially flat against a player's leg 22. The first part 12 may on its outer side bear advertising, sponsorship or endorsement material or otherwise. The first part 12 may be made for instance of polyester, or a polyester and cotton mix.

The second part 14 comprises a length of a textile tape 24, which tape 24 may be made of polyester or a polyester and cotton mix. The material of the tape 24 has undergone a number of heat compactions such that it provides a maximum stretch of up to between 8 and 16%. This can accommodate the expansion of a player's muscles during exercise.

In considering FIG. 3, the tape 24 includes a first length 26 of fleece and hook fastener extending from a first end of the tape 24 for part of the length thereof. As shown in FIG. 3 the first end is the left hand end, and the first length 26 of fleece and hook fastening is provided on the rear side of the tape 24.

The tape 24 also comprises a central portion 28 which is longer than the first length 26, and then a second length 30 of fleece and hook fastener which is co-operable with the first length 26. The second length 30 is provided on the front side of the tape 24 as shown in FIG. 3, and is of a similar length to the first length 26.

At the second right hand end as shown in FIG. 3 of the tape 24, a tab part 32 is provided in the form of the second end of the tape 24 being folded over and attached to itself, with the tab part 32 extending for a shorter length than the first and second lengths 26, 30.

In use the second part 14 can be threaded through the slots 20 in the first part 12, and the second part 14 can extend around a player's leg 22 and be formed into a loop by engagement of the first and second lengths 26, 30 of fleece and hook fastenings. The second part 14 can be formed into a loop of a comfortable length for a player, and as the player's muscles expand during for instance a football match, this is comfortably accommodated by the stretch provided in the second part 14 formed by heat compaction.

The first part 12 can be worn on the outside of the player's leg 22 as shown to provide a valuable space for advertising, sponsorship or otherwise. If it is required to remove the arrangement 10, for instance in the event of an injury to a player, the loop of the second part 14 can readily be broken by pulling on the respective tab part 32. Obviously the loop in the second part 14 can be reformed when it is required to reattach the arrangement 10. As shown in FIG. 1 the second part 14 can also be used to support a wearer's football stockings 34.

A security indication may be provided in the first and/or second parts, and this could be provided for instance by a security yarn which is not visible by the naked eye, but can be detected using for instance a laser. This feature could be used to confirm authentic merchandising.

There is thus described a display arrangement which permits advertising, sponsorship or endorsement material to be comfortably worn by a player, whilst providing additional sponsored areas which can be viewed for instance by a television viewer, and particularly for instance when a player is kicking the ball, tackling, or otherwise

Various modifications may be made without departing from the scope of the invention. For instance the first part may take a number of different forms or shapes, and can be made from a different material. The second part could engage with the first part in a different way, and the first part could for instance include a sleeve through which the second part extends. The second part may take a different form and different engagement means could be provided thereon. The tab part could also take a different form.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A display arrangement to be worn when playing sport, the arrangement including a first part which is at least generally planar and can bear an image or other decoration, and a second part which is flexible and elongate and can support the first part and can be formed into a loop to extend around a player's lower leg and to be worn thereon.

2. An arrangement according to claim 1, in which a tab part is provided on the second part which extends outwardly therefrom when the second part is in a loop, which tab part can be pulled to break open the loop to enable the arrangement to be removed from a player.

3. An arrangement according to claim 1 or 2, in which a first engagement part is provided at one end of the second part, with a second engagement part provided at least towards the other second end of the second part, which first and second engagement parts are engageable together to form the second part into a loop.

4. An arrangement according to claim 3, when dependent on claim 2, in which the tab part is provided at the second end of the second part.

5. An arrangement according to claim 4, in which the tab part is provided at the second end beyond the second engagement part.

6. An arrangement according to claim 4 or 5, in which the tab part is in the form of the second end of the second part being folded back onto itself and mounted together to provide a tab part of double thickness.

7. An arrangement according to any of the preceding claims, in which the first and second engagement parts are provided by respective engageable strips of fleece and hook fastener.

8. An arrangement according to claim 7, in which the first and second engagement strips are provided on respective opposite sides of the second part.

9. An arrangement according to any of the preceding claims, in which the second part is in the form of a length of textile material.

10. An arrangement according to claim 9, in which the second part is in the form of a tape.

11. An arrangement according to claim 9 or 10, in which the textile material has a limited amount of stretch.

12. An arrangement according to claim 11, in which the amount of stretch is up to between 5 and 20%.

13. An arrangement according to claim 12, in which the amount of stretch is up to between 8 and 16%.

14. An arrangement according to any of claims 11 to 13, in which the stretch in the material of the second part is provided by applying a plurality of heat compactions of the material of the second part.

15. An arrangement according to any of claims 9 to 14, in which the second part is made from polyester.

16. An arrangement according to any of claims 9 to 14, in which the second part is made from a polyester and cotton mix.

17. An arrangement according to any of the preceding claims, in which the first part includes a pair of spaced openings through which the second part can extend to retain the first part on the second part when in the form of a loop.

18. An arrangement according to any of the preceding claims, in which the first part is made of a flexible textile material.

19. An arrangement according to claim 18, in which the first part is made of polyester.

20. An arrangement according to claim 18, in which the first part is made of a polyester and cotton mix.

21. An arrangement according to any of the preceding claims, in which the first part is configured so as to generally lie against a wearer of the arrangement in use.

22. An arrangement according to any of the preceding claims, in which a decal is applied to the first part.

23. An arrangement according to claim 22, in which the decal is personalised to a wearer of the arrangement.

24. An arrangement according to claim 23 or 24, in which the decal is a heat press transfer.

25. An arrangement according to any of the preceding claims, in which the arrangement includes a security marking provided therein.

26. An arrangement according to any of the preceding claims, in which the security marking is not substantially visible to the naked eye.

27. An arrangement according to claim 26, in which the security marking is not visible using a laser.

28. A display arrangement substantially as hereinbefore described and with reference to the accompanying drawings.

29. Any novel subject matter or combination including novel subject matter disclosed herein, whether or not within the scope of or relating to the same invention as any of the preceding claims.
